(19) United States
(12) Patent Application Publication
(10) Pub. No.: US 2003/0145222 A1
(43) Pub. Date: Jul. 31, 2003

(54) Apparatus for setting access requirements

(75) Inventors: Mihaela Gittler, Corenc (FR); Stephanie Riche, Grenoble (FR); Marco Casassa Mont, Bristol (GB); Keith Alexander Harrison, Woodcroft Chepstow (GB); Gavin Brebner, St. Martin D'Uriage (FR)

Correspondence Address: HEWLETT-PACKARD COMPANY, Intellectual Property Administration, P.O. Box 272400, Fort Collins, CO, 80527-2400, US

(73) Assignee: HEWLETT-PACKARD COMPANY

(21) Appl. No.: 10/313,868

(22) Filed: Dec. 6, 2002

(30) Foreign Application Priority Data
Jan. 31, 2002 (GB) 0202137.6

(51) Int. Cl. H04L 9/00

(52) U.S. Cl. 713/200

(57) ABSTRACT

A computer system comprising a trust engine for determining a trust level associated with a computer node and a policy engine for setting access requirements to a personal profile, from the computer node, based upon the determined trust level of the computer node and respective sensitivity levels associated with sub-components of the personal profile.

### FIELD OF THE INVENTION

The present invention relates to an apparatus for setting access requirements.

### BACKGROUND OF THE INVENTION

To allow easy adaptation of a computer apparatus's environment to a specific user there has been a trend towards using personal profiles, where the personal profiles contain information specific to a user. The user's personal profile is loaded into computer apparatus's associated with the user to allow the computer apparatus's to automatically configure themselves for the user based upon the contents of the personal profile.

The personal profile typically includes data personal to the user (e.g. user attributes such as credit card information, user subscription information) that can be used to define the user operating space, such as accessible computer functionality and subscribed services.

Though this has the advantage of allowing computing devices to automatically configure themselves for a particular user this correspondingly can cause problems should the computing device be accessible by other users, whether with or without the authorised user's permission. This has the disadvantage of potentially allowing unauthorised access to the user's personal data and/or allowing the unauthorised user to pass themselves off as the user.

This can be a problem if the user's personal profile is loaded on a single computing device, especially if it is common place to lend that type of computing device, for example a radiotelephone.

Further, with the increasing trend for a user to have a number of computing devices to support their every day activities, (for example it is not unusual for a user to have a radiotelephone, a work computer, a home computer and a PDA), it has become desirable for users to have their personal profile downloaded on all their computing devices, ensuring that each of the user's computing devices are configured in the same way.

Typically, however, as the number of computer apparatus the user has access to increases the number of other users that may have access to these computer apparatus's increases, whether it's the loan of a radiotelephone or the use of a user's work computer by a colleague.

To prevent unauthorised access to computer devices some computer devices, for example radiotelephones, allows a user to lock the operation of the device by the pressing of a known set of keys. However, the locking operation restricts access to all of the devices functionality, which would be undesirable to a user wishing to loan the computing device albeit with reduced functionality.

### SUMMARY OF THE INVENTION

In accordance with a first aspect of the present invention there is provided a computer apparatus comprising a trust engine for determining a trust level associated with the computer apparatus; and a policy engine for setting access requirements to data attributes based upon a sensitivity level associated with the respective data attributes and the determined trust level of the computer apparatus.

This provides the advantage of allowing the computer apparatus to dynamically set the access requirements to a personal profile based upon both the trust level of the computer apparatus and the sensitivity level associated with personal profile. Therefore, as the trust level of the computer apparatus changes and/or the sensitivity level of the personal profile changes the computer apparatus changes the access requirements to the personal profile according to the policy engine rules.

Suitably the trust level determination is based upon the activation or deactivation of a switch.

Suitably the trust level determination is based upon time of day.

Suitably the trust level determination is based upon location of the computer apparatus.

Suitably the trust level determination is based upon the user of the computer apparatus.

Preferably the access requirements determine which data attributes can be displayed to a user.

Preferably the access requirements determine whether any data attributes are to be encrypted.

Preferably the access requirements determine whether any data attributes are to be deleted.

Preferably the access requirements determine whether any data attributes are to be transferred to another computer apparatus.

In accordance with a second aspect of the present invention there is provided a computer apparatus comprising a trust engine for determining a trust level associated with the computer apparatus; and a policy engine for setting access requirements to functionality of the computer apparatus based upon a sensitivity level associated with the respective computer apparatus functionality and the determined trust level of the computer apparatus.

In accordance with a third aspect of the present invention there is provided a computer apparatus comprising a trust engine for determining a trust level associated with the computer apparatus and a policy engine for setting access requirements to a personal profile based upon the determined trust level of the computer apparatus and respective sensitivity levels associated with sub-components of the personal profile.

In accordance with a fourth aspect of the present invention there is provided a computer system comprising a trust engine for determining a trust level associated with a computer node and a policy engine for setting access requirements to data attributes, from the computer node, based upon a sensitivity level associated with the respective data attributes and the determined trust level of the computer node.

In accordance with a fifth aspect of the present invention there is provided a computer system comprising a trust engine for determining a trust level associated with a computer node and a policy engine for setting access requirements to functionality of the computer node based upon a sensitivity level associated with the respective functionality of the computer node and the determined trust level of the computer node.

In accordance with a sixth aspect of the present invention there is provided a computer system comprising a trust engine for determining a trust level associated with a computer node and a policy engine for setting access requirements to a personal profile, from the computer node, based upon the determined trust level of the computer node and respective sensitivity levels associated with sub-components of the personal profile.

### BRIEF DESCRIPTION OF THE DRAWINGS

For a better understanding of the present invention and to understand how the same may be brought into effect reference will now be made, by way of example only, to the accompanying drawings, in which:

FIG. 1 illustrates a computer apparatus according to one embodiment of the present invention;

FIG. 2 illustrates a computer system according to one embodiment of the present invention.

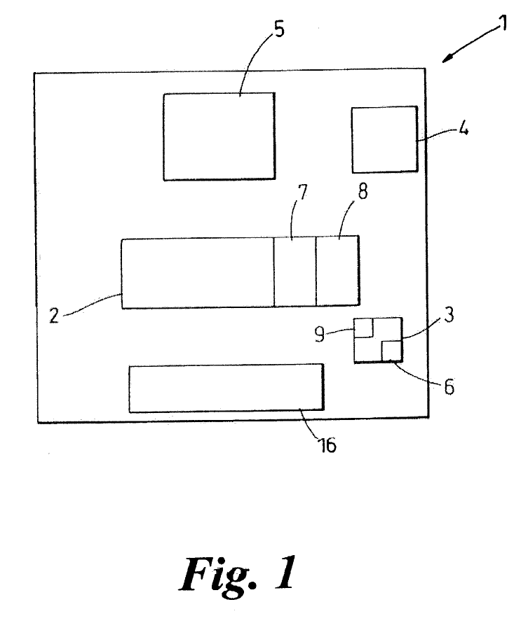

FIG. 1 shows a computer platform 1 (i.e. computer apparatus) having a controller 2, e.g. a central processor unit, memory 3, an input/output interface 4 and to provide a user interface to the computer platform a display 5 and keyboard 16.

### DETAILED DESCRIPTION OF THE INVENTION

Loaded in memory 3 is a personal profile 6 for a user of the computer platform 1. The personal profile 6 contains information specific to the user that allows a computing environment to be adopted for the user on the computer platform 1. The personal profile 6 typically includes sensitive user data, such as user attributes, and computer apparatus configuration data, such as user accessible computer functionality and services. The contents of the personal profile 6 have associated with them a sensitivity level where the sensitivity levels assigned are dependent upon the type and characteristics of the data. For example, if all data within a personal profile can be categorised as either secret or non-secret there is only need for two sensitivity levels, secret and non-secret. Typically, however, there will be a need to categorise data sensitivity with greater refinement than is possible with only two sensitivity levels. Preferably the profile data is partitioned such that all data assigned with the same sensitivity level are contained within the same partition.

For illustration purposes Table 1 shows a simplistic personal profile and associated sensitivity levels.

TABLE 1

| Attributes | Functionality | Sensitivity |
|---|---|---|
| A | B | Secret |
| none | C | Restricted Technology |
| D | E | Company Confidential |
| F | G | Non-Secret |

The personal profile illustrated in table 1 splits the contents of the personal profile into ‘Attributes’ and ‘Functionality’, however any suitable categorisation may be used. Four sensitivity levels have been assigned to the personal profile, Secret, Restricted Technology, Company Confidential, and Non-Secret. All attributes classified as ‘Secret’ are labelled A, whereas functionality classified as ‘Secret’ have been labelled B. All functionality classified as ‘Restricted Technology’ have been labelled C. All attributes that have been classified as ‘Company Confidential’ have been labelled D, whereas functionality classified as ‘Company Confidential’ have been labelled D. All attributes that have been classified as ‘Non-Secret’ have been labelled F, whereas functionality classified as ‘Non-Secret’ have been labelled G.

The controller 2 is configured to execute both a trust engine 7 and a policy engine 8 where the distinction between the trust engine 7 and the policy engine can be either physical or logical. Where there is only a logical separation between the trust engine 7 and the policy engine 8 a multipurpose engine can be executed that uses trust rules to implement the trust engine functionality and policy rules to implement the policy engine functionality. However, either or both the trust engine 7 and/or the policy engine 8 can be executed on stand-alone devices, for example a trusted device (not shown) as defined in TRUSTED COMPUTING PLATFORM ALLIANCE—TCPA specification V1.1; http://www.trustedpc.org/home/home.htm.

The trust engine 7 assigns a trust level to the computer platform 1 dependent upon predetermined criteria. For example, the trust level may be dependent upon the person accessing the computer platform 1, the computer platform characteristics (i.e. the computer platform hardware configuration); the location of the computer platform 1; the time of day; the operational status of the computer platform 1 (i.e. whether the computer platform 1 is operating correctly); user selection or any combination of the above. To allow the trust engine 7 to determining a trust level for the computer platform 1 based upon the predetermined criteria the trust engine 7 will typically require access to ancillary information. For example, biometric and/or smart card facilities (not shown) could be used by the trust engine 7 to determine the identity of a the person accessing the computer platform 1; computer platform built in test facilities (not shown) could used to determine the computer platform characteristics and/or the computer platform status; a global positioning system (GPS) (not shown) facility could be used to determine the location of the computer platform 1; and a switch facility (not shown) could be used by a user to select a specific trust level for the computer platform 1. For example, the trust engine 7 could be configured to recognised the pressing of a set key or keys on the keyboard 16 to identify an emergency condition that requires the trust engine 7 to set the trust level of the computer platform 1 to its lowest setting. Alternatively, or in addition, the trust engine 7 could be configured to recognise the operation of switch (not shown) to raise or lower the trust level incrementally. The trust level assigned to the computer platform 1 will typically be a indication of how secure the computer platform 1 is from unauthorised access.

For illustration purposes Table 2 shows four trust levels assignable to a computer platform. However, many other trust levels could be assigned.

TABLE 2

| Trust Level | Definition |
|---|---|
| W | Fully Secure |
| X | Not within a specified |
| | country |
| Y | Not in use by a company |
| | employee |
| Z | Status unknown |

The policy engine 8, using the policy rules 9 as described below, is configured to set the access requirements to the contents of the personal profile 6 based upon the trust level determined for the computer platform 1 and the sensitivity levels associated with the contents. The policy rules 9, in this embodiment, are stored in memory 3 and accessed by the policy engine 8 on powering up of the computer platform 1.

The policy rules 9 define the criteria for accessing the contents of a personal profile 6 based upon the sensitivity levels assigned to the contents and the trust level associated with a computer platform 1. Additionally, when access to the contents of the personal profile 6 is too restricted the policy rules 9 also define how the contents are to be ‘secured’ from access by unauthorised users.

For example, based upon the sensitivity levels and trust levels illustrated in tables 1 and 2 above, the policy rules 9 could be written to stipulate that when the trust level of the computer platform 1 is fully secure (i.e. level W) all the contents of the personal profile 6 (i.e. A to H) are accessible from the computer platform 1. However, for a trust level Y (i.e. when the computer platform 1 is to be used in a restricted country) the policy rules 9 then stipulate that access to functionality D is to be prevented. Further, when the trust level can not be accurately determined (i.e. level Z) the policy rules 9 then stipulate that access to all the contents of the personal profile 6, other than non-secret, is to be prevented.

In addition to defining personal profile access requirements the policy rules 9 can also stipulate how, when necessary, access to the contents of the personal profile 6 is to be restricted. For example, the policy rules 9 may contain instructions that access to the contents of the personal profile 6 is to be restricted by encryption, deletion, transferring of the contents to another computer platform or instructions that no visible icon should be displayed to indicate the presence of the contents on the computer platform 1.

The policy engine 8 is responsive to inputs from the trust engine 7 and variations in policy rules 9 and personal profile 6 sensitivity levels for dynamically setting the access requirements to the contents of a personal profile 6, such as data attributes, service access and computer functionality. Dependent upon the access criteria defined in the policy rules 9 the policy engine 8 initiates appropriate mechanisms (e.g. encryption or deletion) for restricting access to the contents of the personal profile 6 in accordance with the instructions specified in the policy rules 9.

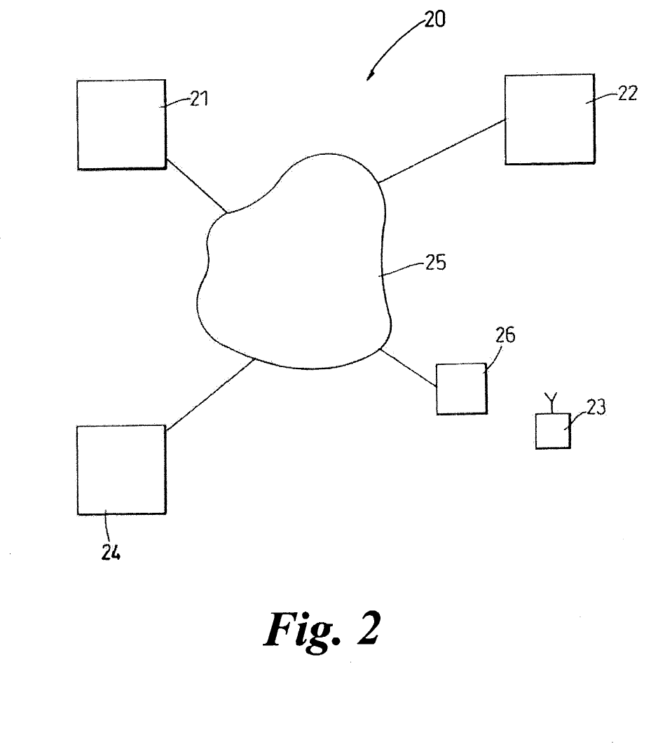

FIG. 2 shows computer system 20 comprising four computer nodes 21, 22, 23, 24 coupled via a network 25, for example the Internet.

The computer nodes 21, 22, 23, 24 are assigned to a single user and represent a user's computing domain.

Each of the computer nodes 21, 22, 23, 24 are based upon the same design as computer platform 1 and include a controller (not shown), e.g. a central processor unit, memory (not shown), an input/output interface (not shown) and to provide a user interface to the computer platform a display (not shown) and keyboard (not shown). As described above the controllers are configured to execute a trust engine (not shown) and policy engine (not shown) for setting access requirements to the contents of the user's personal profile (not shown).

In this embodiment computer node 21 is the user's main work computer coupled to the network 25 via input/output interface, where computer node 21 is designated as the user's domain device manager, as described below. Computer node 22 is the user's laptop computer. Computer node 23 is a radiotelephone, coupled to the network 25 via a WAP server 26. Computer node 24 is the user's personal digital assistant PDA.

Computer node 21, acting as the user's domain device manager, is arranged to manage the user's personal profile for use in the user's computing domain by, for example, maintaining a master copy of the user's personal profile, distributing copies of the user's personal profile to each of the user's computer nodes 22, 23, 24 to allow each of the computer nodes environments to be automatically configured for the user using the same version of the user's personal profile.

In addition to each computer node 21, 22, 23, 24 being arranged to set their own access requirements the trust engine (not shown) in computer node 21 (i.e. the domain device manager) is also configured to monitor, via the network 25, the trust levels assigned to the other computer nodes 22, 23, 24 within the user domain and set the access requirements for each computer node 22, 23, 24 to the contents of the user's personal profile according to the policy rules. To implement the access requirements computer node 21 may only down load a sub-set of the personal profile to the relevant computer node 22, 23, 24 (i.e. only the contents of the personal profile that comply with the access requirements).

If a user sets the access requirements for a computer node 22, 23, 24 remotely (e.g. using a switch, as described above, on the user's domain device manager computer platform 21) it is desirable that conventional security features are utilised to allow the remote computer node 22, 23, 24 to authenticate the user and ensure that the user is authorised to perform the required task.

What is claimed:

1. A computer apparatus comprising a trust engine for determining a trust level associated with the computer apparatus; and a policy engine for setting access requirements to data attributes based upon a sensitivity level associated with the respective data attributes and the determined trust level of the computer apparatus.

2. A computer apparatus according to claim 1, wherein the trust level determination is based upon the activation or deactivation of a switch.

3. A computer apparatus according to claim 1, wherein the trust level determination is based upon time of day.

4. A computer apparatus according to claim 1, wherein the trust level determination is based upon location of the computer apparatus.

5. A computer apparatus according to claim 1, wherein the trust level determination is based upon the user of the computer apparatus.

6. A computer apparatus according to any preceding claim, wherein the access requirements determine which data attributes can be displayed to a user.

7. A computer apparatus according to any preceding claim, wherein the access requirements determine whether any data attributes are to be encrypted.

8. A computer apparatus according to any preceding claim, wherein the access requirements determine whether any data attributes are to be deleted.

9. A computer apparatus according to any preceding claim, wherein the access requirements determine whether any data attributes are to be transferred to another computer apparatus.

10. A computer apparatus comprising a trust engine for determining a trust level associated with the computer apparatus; and a policy engine for setting access requirements to functionality of the computer apparatus based upon a sensitivity level associated with the respective computer apparatus functionality and the determined trust level of the computer apparatus.

11. A computer apparatus according to claim 10, wherein the trust level determination is based upon the activation or deactivation of a switch.

12. A computer apparatus according to claim 10, wherein the trust level determination is based upon time of day.

13. A computer apparatus according to claim 10, wherein the trust level determination is based upon location of the computer apparatus.

14. A computer apparatus according to claim 10, wherein the trust level determination is based upon the user of the computer apparatus.

15. A computer apparatus comprising a trust engine for determining a trust level associated with the computer apparatus and a policy engine for setting access requirements to a personal profile based upon the determined trust level of the computer apparatus and respective sensitivity levels associated with sub-components of the personal profile.

16. A computer apparatus according to claim 15, wherein the sub-components include data attributes.

17. A computer apparatus according to claim 15 or 16, wherein the sub-components include computer apparatus functionality.

18. A computer apparatus according to claim 15, wherein the trust level determination is based upon the activation or deactivation of a switch.

19. A computer apparatus according to claim 15, wherein the trust level determination is based upon time of day.

20. A computer apparatus according to claim 15, wherein the trust level determination is based upon location of the computer apparatus.

21. A computer apparatus according to claim 15, wherein the trust level determination is based upon the user of the computer apparatus.

22. A computer system comprising a trust engine for determining a trust level associated with a computer node and a policy engine for setting access requirements to data attributes, from the computer node, based upon a sensitivity level associated with the respective data attributes and the determined trust level of the computer node.

23. A computer system according to claim 22, wherein the trust level determination is based upon the activation or deactivation of a switch.

24. A computer system according to claim 22, wherein the trust level determination is based upon time of day.

25. A computer system according to claim 22, wherein the trust level determination is based upon location of the computer apparatus.

26. A computer system according to claim 22, wherein the trust level determination is based upon the user of the computer apparatus.

27. A computer system according to any of claims 22 to 26, wherein the access requirements determine which data attributes can be displayed to a user.

28. A computer system according to any of claims 22 to 26, wherein the access requirements determine whether any data attributes are to be encrypted.

29. A computer system according to any of claims 22 to 26, wherein the access requirements determine whether any data attributes are to be deleted.

30. A computer system according to any of claims 22 to 26, wherein the access requirements determine whether any data attributes are to be transferred to another computer apparatus.

31. A computer system comprising a trust engine for determining a trust level associated with a computer node and a policy engine for setting access requirements to functionality of the computer node based upon a sensitivity level associated with the respective functionality of the computer node and the determined trust level of the computer node.

32. A computer system according to claim 31, wherein the trust level determination is based upon the activation or deactivation of a switch.

33. A computer system according to claim 31, wherein the trust level determination is based upon time of day.

34. A computer system according to claim 31, wherein the trust level determination is based upon location of the computer apparatus.

35. A computer system according to claim 31, wherein the trust level determination is based upon the user of the computer apparatus.

36. A computer system comprising a trust engine for determining a trust level associated with a computer node and a policy engine for setting access requirements to a personal profile, from the computer node, based upon the determined trust level of the computer node and respective sensitivity levels associated with sub-components of the personal profile.

37. A computer system according to claim 36, wherein the sub-components include data attributes.

38. A computer system according to claim 36 or 37, wherein the sub-components include computer apparatus functionality.

39. A computer system according to claim 36, wherein the trust level determination is based upon the activation or deactivation of a switch.

40. A computer system according to claim 36, wherein the trust level determination is based upon time of day.

41. A computer system according to claim 36, wherein the trust level determination is based upon location of the computer apparatus.

42. A computer system according to claim 36, wherein the trust level determination is based upon the user of the computer apparatus.

43. A computer apparatus comprising a processor for determining a trust level associated with the computer apparatus and for setting access requirements to a personal profile based upon the determined trust level of the computer apparatus and respective sensitivity levels associated with sub-components of the personal profile.

44. A computer system comprising a processor for determining a trust level associated with a computer node and for setting access requirements to a personal profile, from the computer node, based upon the determined trust level of the computer node and respective sensitivity levels associated with sub-components of the personal profile.
